(19) United States
(12) Patent Application Publication
(10) Pub. No.: US 2002/0173300 A1
(43) Pub. Date: Nov. 21, 2002

(54) Method and system for completing incomplete addressing data sent to a communication device

(76) Inventors: Yuri Shtivelman, San Francisco, CA (US); David Ian Hopper, Sunnyvale, CA (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/941,969

(22) Filed: Aug. 28, 2001

Related U.S. Application Data
(60) Provisional application No. 60/292,836, filed on May 21, 2001.

(51) Int. Cl. H04M 3/00

(52) U.S. Cl. 455/418; 455/566; 455/575

(57) ABSTRACT

A method and system for context-based data completion is described. In one embodiment, information is inputted by a user into a wireless device (or the like), and based on specific addressing data of information provided by the user, additional data is appended to some of the data entered into the wireless device in order to facilitate communication to a separate device.

In alternative embodiments, addressing datum completion logic used to determine the data needed to add to a partial addressing datum may be incorporated within a graphical user interface or may be server-based. In alternative embodiments, the directory used with the addressing datum completion logic may be incorporated into the addressing datum completion logic, may reside within a wireless device for use with the addressing datum completion logic, or may be server-based.

The present application claims priority to the provisional filed application entitled Context-Based Completion of Incomplete Phone Numbers in Text Messages, filed on May 21, 2001, U.S. patent application Ser. No. 60/292,836, which is also incorporated herein by reference.

### FIELD OF THE INVENTION

The present invention relates generally to the field of data communications.

### BACKGROUND

Today more and more people can connect wirelessly and have the ability to receive messages, email, etc., on various kinds of communication devices. Some of these devices also feature a phone functionality, which may allow email to be received in a phone, or allow an organizer to have a phone attachment, or have some other similar functionality. When sending text messages, people often may write the fewest number of digits required to give a local phone number (the base phone number), or write only a small portion of an email address or other similar addressing datum. As a consequence, the phone or phone system is unable to connect to another device using a partial addressing datum (e.g., number or email address) when the partial addressing datum is selected in a text message displayed on the screen of a communication device. The system is not able to connect because the addressing datum may not have the necessary system is not able to connect because the addressing datum may not have the necessary information it needs to complete the communication (e.g., lacking an area code, country code, or other additional prefixes and/or suffixes for the phone number, or missing a section of an email address, etc.). As a result, faster, more efficient communication cannot occur.

In sending and receiving messages, users prefer the most expedient method of communicating. A quicker method of communication between a user of a communication device and a message recipient would be useful—especially if the user does not have to add any additional data himself in order to facilitate communication.

### SUMMARY OF THE INVENTION

In one embodiment, a method and system for context-based data completion is disclosed. In one embodiment, a communication device provides an interface to receive data input, and automatically appends additional data to the data entered to facilitate communication to a separate device. The communication device uses addressing datum completion logic and a directory, either of which may be incorporated within the communication device or on a separate server, according to alternative embodiments.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a block diagram showing a message entered by a user, according to one embodiment.

FIG. 2 is a block diagram identifying the selected elements in a message provided by a user, according to one embodiment.

FIG. 3 is a flow diagram describing extracting a partial addressing datum entered by a first user and completing the addressing datum, according to one embodiment.

FIG. 4 is an illustration of the architecture of a system employed to provide context-based data completion, according to one embodiment.

### DETAILED DESCRIPTION OF THE INVENTION

In the following description, various aspects of the present invention will be described. However, it will be apparent to those skilled in the art that the present invention may be practiced with only some or all aspects of the present invention. For purposes of explanation, specific configurations are set forth in order to provide a thorough understanding of the present invention. However, it will also be apparent to one skilled in the art that the present invention may be practiced without the specific details. In other instances, well-known features are omitted or simplified in order not to obscure the present invention. While the following discussion generally makes reference to a phone system, it is understood that the processes and devices set forth are equally applicable to SMS devices.

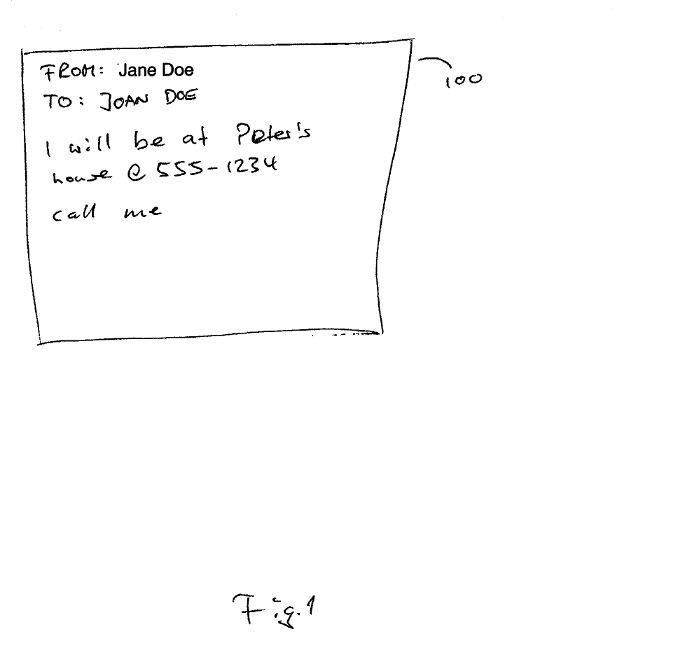

Referring now to FIG. 1, a message 100 is shown from Jane Doe to John Doe. The message 100 gives a specific number for a specific place (“Pete's house”) at which a sender may be called. This message could be an email, a text message typed on a short message system (SMS) device, a fax rendered into text through an optical character recognition (OCR) application, or some other text message, according to varying embodiments.

The message 100 may be received on a wireless device. In another embodiment, the message 100 may be networked using fixed wireless, fiber, laser, satellite, cable dial-up or a permanent link phone, data networks, etc. The message 100 may be received on any of a variety of systems, including, but not limited to, a standalone system, a networked system, a system within a home, or a system within corporate or government offices.

In the example illustrated in FIG. 1, the message 100 does not give the location of “Pete's house,” nor does it include an area code or similar location code with the phone number. If Jane, John, and Pete all live in the same region with the same area code, the phone number may be adequate in order to dial. However, if Jane is in a different location from John, or if John doesn't know Pete, then John may not know what area code or similar location code to prepend to the phone number to call Jane.

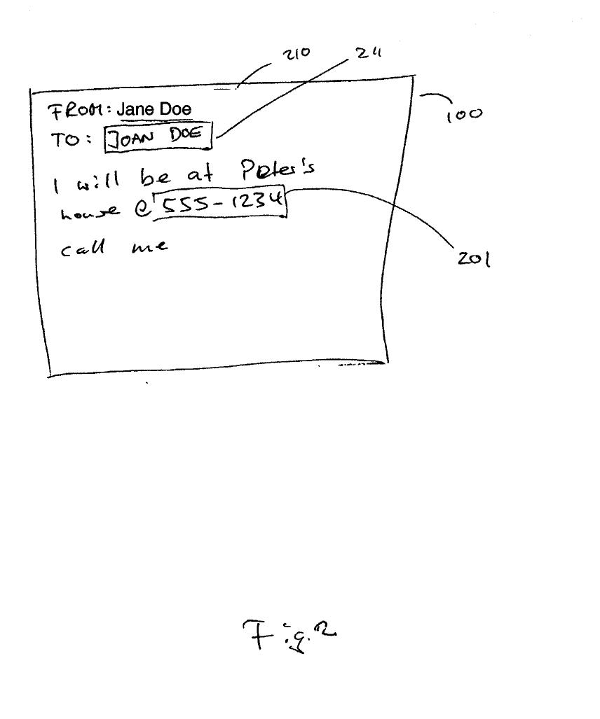

FIG. 2 shows the selected elements in the message that may be used to extract possible additional numbers to complete the phone base number, according to one embodiment. Addressing data of information, in one example, are a base phone number 201, the sender 210, and the recipient 211. Analyzing logic (e.g., parser software or circuitry) can parse the text to find phone numbers and distinguish phone numbers from other numbers. Typically, phone numbers have a specific format, so the logic can detect the specific number format. In some cases, the logic can also detect related words or phrases nearby, such as “phone,” “call,” “number,” and other similar words to aid in determining whether the number is a phone number. In an alternative embodiment, the logic may even use numbers that are incorrectly formatted.

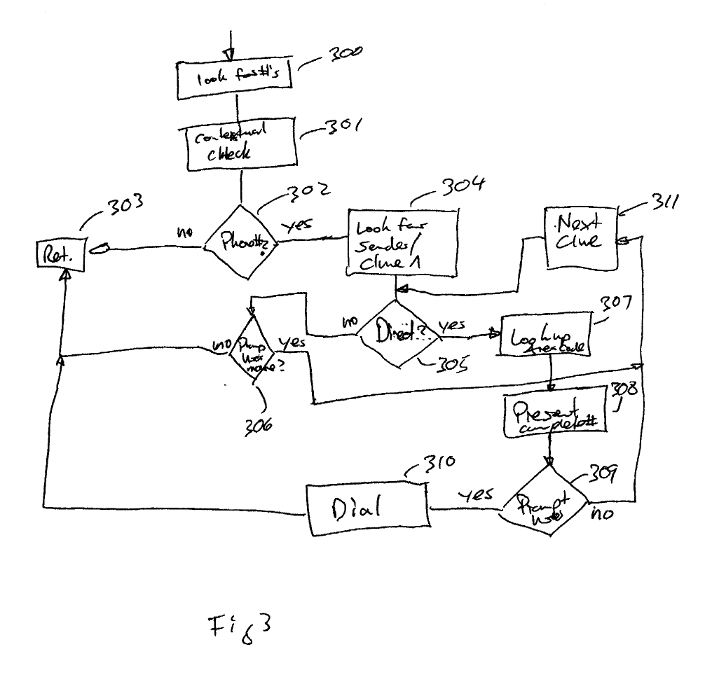

FIG. 3 is a flow diagram describing how one embodiment may be used to extract the base phone number and then to complement it with additional data, such as area codes and other additional numbers as appropriate. While the figure and the following text may explain the process as an interactive one, it is understood that the process explained may occur without interaction from a user at various points in the process. In step 300, numbers in the message are parsed to distinguish the numbers from the text. Step 301 then provides a contextual check to determine whether the detected numbers may be phone numbers or other types of identifiable numbers or text. Step 302 determines whether a possible phone number is detected and then the logic branches, depending on if it is or is not detected. If no possible phone number is detected, the process terminates at step 303.

However, if the process does detect a possible phone number, in step 304, a first clue is sought. The first clue may be an addressing datum such as the initial message sender (210 in FIG. 2) who would usually write numbers that are “local” from her point of view (such as numbers in the same area code.) If the number is local, the message sender may write the phone number without an area code. A message sender would tend to write telephone numbers that are located in another region with their area code. Therefore, knowing the message sender's area code may be a good indication of an area code of a phone number written without the area code.

Then, once a clue (such as the sender) is identified, the process in step 305 searches a directory for a listing for the sender. If the sender is listed, in step 307, the process looks up the sender's area code or similar location code. The process then attaches the appropriate area code in step 308 to the base phone number. Additional numbers, such as 1 or +1, may also be added according to the location of the caller in relation to the message sender. Furthermore, in one embodiment, based on the location of the caller, country codes may be added or dropped from the numbers stored in the caller's directory so that the number dialed from the directory will be valid. This may be done even in the absence of messages received from a message sender. This is possible because the system can discover the location of the caller. The completed number is then presented to the user (the one who intends to send a new message).

The user is prompted to select the completed number for dialing in step 309. If the user accepts the prompt, in step 310, the number is dialed. When the number is dialed, the process terminates at step 303. However, if the user does not elect to dial the number in response to the prompt in step 309, the process moves to step 311, where it searches for a next clue. The next clue may be an addressing datum, such as the message recipient, a name or names found near the base phone number when the message was parsed, the original message sender's email address, or a variety of other clues.

After the process is routed to step 311 to find the next clue, the process then starts again at step 305, searches the directory for the next clue, and continues forth in the manner described above. If the clue is not in the directory and a corresponding number cannot be found, the process branches to step 306, where it prompts the user to select whether to continue to search for more clues or to end the attempt. If the user wants to search for more clues, the process returns to step 311, the clue counter is increased, and the process searches for additional clues. If the user does not want to continue, the process terminates at step 303.

Additional clues for step 311 may be related to the initial sender's or recipient's company, such as the name of the company or the initial sender's or recipient's email address. The clue may give the rest of the phone number if the sender has entered only an extension number for the company at which the sender or the recipient works. For example, Jane may work at XYZ company and she may give only an extension number, such as x2323, for Pete's office. Some logical clues, then, would be to look up company XYZ's number or Jane's number and incorporate the extension number into the number found in the directory. An extension could be used with a company telephone number in one of two ways. For an inward dialing system, the extension would be overlaid as the last four (or however many) digits of the phone number. In other cases, the extension would be appended after the phone number, with pauses inserted for dialing.

Other clues may be used, such as determining the city or other location of the company based on the email address of the initial message sender or the email address of another person (i.e., Pete). There are many other, similar clues that may be used to determine the area code or location code for a phone number, all of which may be included in alternative embodiments.

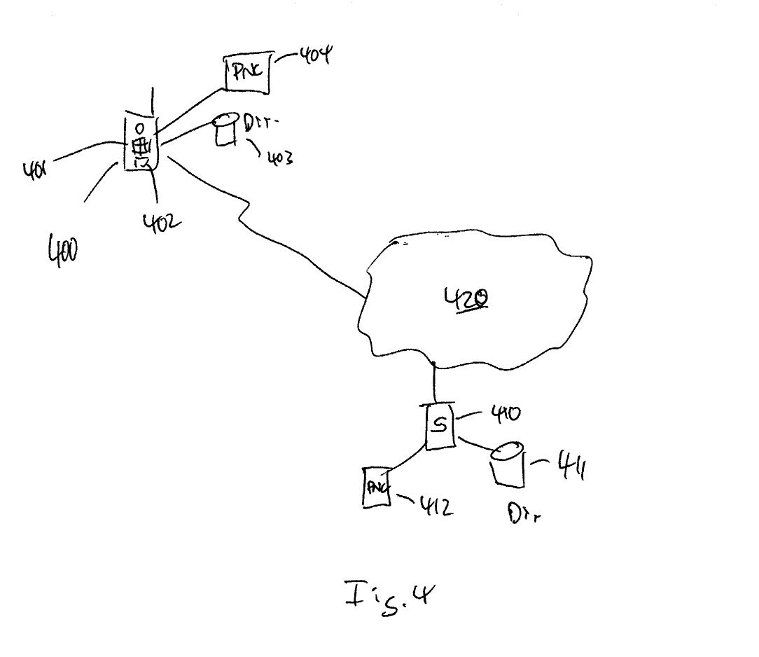

FIG. 4 illustrates the architecture of a system employed for one embodiment. The communication device 400 has, in addition to its basic phone functions (not shown), a graphical user interface to allow for user input. The graphical user interface has an input device 401, such as the phone keypad, an additional keyboard or a touch screen, and a screen 402 where messages are viewed. In one embodiment, phone number completion (PNC) logic 404 may be incorporated into the interface. A directory 403 may be incorporated into the interface in some instances.

In one embodiment, the communication device 400 may be connected to a server 410 though a network 420. Phone number completion software 412 may reside at the server 410, according to one embodiment. A directory 411 may also reside at the server 410 in some instances, according to one embodiment. Depending on a variety of factors, many alternative embodiments may include various combinations of locations of the PNC logic 404 or 412 or the directory 403 or 411. For example, the PNC logic 404 may reside within the communication device itself, but could use the directory 411 on the server 410.

In some embodiments, the server 410 may not reside on the network 420 of the service provider. Instead, the server may reside on the Internet or a separate network and may be connected via any of a variety of WAN connections through the network to the communication device.

In an alternative embodiment, voice recognition may be applied in some cases to a voice message (and may therefore be able to detect phone numbers through voice spotting technology), thus allowing for automatic dialing of phone numbers that were left in a voice mail.

Additionally, the one embodiment may allow for easier peer-to-peer communication by completing data other than phone numbers. In an alternative embodiment, email addresses may be completed using processes similar to the phone number completion logic. For example, a message sender (Jane) may write to a recipient (John) asking the recipient to email the sender or email a friend (Pete). A partial email address may be provided or an email address may not be provided at all. The logic may then be used to identify the missing portion of an email or the entire address if it is missing, based on clues provided within the message. Other addressing data within the message, such as the name “Pete,” Pete's partial phone number, or Pete's partial email address, are identified as clues by the logic, then these addressing data are compared to data provided within a directory. Using the logic and the identified clues, Pete's full email address is determined and either the missing portion is added to the partial email address or the entire email address appears on the interface screen for a message sender to choose whether or not to use.

The processes and embodiments as described above can be stored on machine-readable medium as instructions. The machine-readable medium includes any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.). The device or machine-readable medium may include a solid state memory device and/or a rotating magnetic or optical disk. The device or machine-readable medium may be distributed when partitions of instructions have been separated into different machines, such as across an interconnection of computers.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method comprising providing for completion of an incomplete addressing datum sent to a communication device, wherein completion is accomplished by an analyzing logic searching for at least one clue.

2. The method of claim 1, wherein the incomplete addressing datum is a partial phone number.

3. The method of claim 1, wherein the incomplete addressing datum is a partial email address.

4. The method of claim 1, wherein the analyzing logic is incorporated into the communication device or resides on a server.

5. The method of claim 1, wherein a directory searched by the analyzing logic is incorporated into the communication device or resides on a server.

6. The method of claim 1, wherein the communication device is a wireless device.

7. The method of claim 1, wherein one of the at least one clue is a sender's identity.

8. A machine-readable medium that provides instructions which, when executed by a machine, cause the machine to perform operations comprising providing for completion of an incomplete addressing datum sent to a communication device, wherein completion is accomplished by an analyzing logic searching for at least one clue.

9. The machine-readable medium of claim 8, wherein the incomplete addressing datum is a partial phone number.

10. The machine-readable medium of claim 8, wherein the incomplete addressing datum is a partial email address.

11. The machine-readable medium of claim 8, wherein the analyzing logic is incorporated into the communication device or resides on a server.

12. The machine-readable medium of claim 8, wherein a directory searched by the analyzing logic is incorporated into the communication device or resides on a server.

13. The machine-readable medium of claim 8, wherein the communication device is a wireless device.

14. The machine-readable medium of claim 8, wherein one of the at least one clue is a sender's identity.

15. An apparatus comprising an analyzing logic to search for at least one clue to complete an incomplete addressing datum sent to a communication device.

16. The apparatus of claim 15, wherein the incomplete addressing datum is a partial phone number.

17. The apparatus of claim 15, wherein the incomplete addressing datum is a partial email address.

18. The apparatus of claim 15, wherein the analyzing logic is incorporated into the communication device or resides on a server.

19. The apparatus of claim 15, wherein a directory searched by the analyzing logic is incorporated into the communication device or resides on a server.

20. The apparatus of claim 15, wherein the communication device is a wireless device.

21. The apparatus of claim 15, wherein one of the at least one due is a sender's identity.
